(19) United States
(12) Patent Application Publication
(10) Pub. No.: US 2015/0136754 A1
(43) Pub. Date: May 21, 2015

(54) Wireless Heating System for Motorcycles

(71) Applicant: Keith Yester, Plumas Lake, CA (US)

(72) Inventor: Keith Yester, Plumas Lake, CA (US)

(21) Appl. No.: 14/533,858

(22) Filed: Nov. 5, 2014

Related U.S. Application Data
(60) Provisional application No. 61/900,066, filed on Nov. 5, 2013.

(51) Int. Cl. A41D 19/015; H05B 3/34

(52) U.S. Cl. CPC A41D 19/01535; H05B 3/342
USPC 219/211

(57) ABSTRACT

Disclosed is a wireless heating system for motor vehicles, wherein the system includes gloves and handle bar heating pads, each having imbedded heating elements. The heating elements are in electrical communication with metal contact points disposed on the gloves and the heating pads. The contact points are disposed on locations that correspond to the palm and pinky portions of the user's hand when the user's hand grips the heating pads while wearing the gloves. The heating pads are turned on or off via a power switch, and are in electrical communication with a power source. When the heating pads are on, the heating elements can produce heat while the contact points of the gloves are in direct contact with the contact points of the heating pads, whereby directly contacting the contact points of the gloves and the heating pads complete an electrical circuit to provide power to the heating elements.

### CROSS REFERENCE TO RELATED APPLICATION

This application claims the benefit of U.S. Provisional Application No. 61/900,066 filed on Nov. 5, 2013. The above identified patent application is herein incorporated by reference in its entirety to provide continuity of disclosure.

### BACKGROUND OF THE INVENTION

### Field of the Invention

The present invention relates to a heating system for motor vehicles. More specifically, the present invention pertains to an improved wireless heating system for motorcycles, all-terrain vehicles (ATVs), and the like. The system comprises a pair of gloves and a pair of handle bar heating pads, each having heating elements imbedded therein. The gloves and the heating pads are adapted to establish a complete circuit when in direct contact with another, thereby actuating the heating elements and providing warmth to the user's hands while riding a motor vehicle.

Many individuals enjoy riding motorcycles because of the heightened thrill and the risks of riding a two-wheeled vehicle. Additionally, motorcycles are efficient forms of transportation that impact the environment minimally. For instance, riding motorcycles can double the fuel economy of automobiles. It is also easier to maneuver motorcycles because of its compact size.

While riding motorcycles is enjoyable, it can be uncomfortable to ride motorcycles in inclement weather because motorcycles do not provide a cabin that can enclose the rider. Thus, individuals can be exposed to wind and cold temperature in winter months when riding a motorcycle. To protect themselves from cold weather, individuals generally don heavy clothing and accessories such as riding gloves. Conventional riding gloves, however, do not provide sufficient warmth to the user's hands. As such, individuals' hands can still be susceptible to windburn or numbness from being exposed to cold weather. This can be problematic as numb hands can prevent the individuals from effectively controlling the motorcycle. Therefore, a device that protects the users' hands from cold weather is desired.

The present invention provides a wireless heating system for motor vehicles, and in particular, motorcycles, ATVs, motor bikes, and the like. The system comprises a pair of heated gloves and a pair of handle bar heating pads, each having heating elements imbedded therein. Each of the gloves comprise a set of contact points, wherein the contact points are located on the palm portion and the underside of the pinky portion of the gloves. The contact points comprise metal plates that can conduct electricity. The metal plates are in electrical communication with the heating elements that are imbedded between an outer layer and an inner layer of the gloves.

The handle bar heating pads comprise a second set of contact points. The contact points are disposed on locations that correspond with the palm portion and the pinky portion of the gloves when the user's hand grips the handle bar heating pads. As described above, the contact points comprise metal plates, which are in communication with the heating elements disposed within the heating pads. The heating pads are turned on or off via a power switch that is disposed on an exterior thereof. The power switch and the heating elements of the handle bar heating pads are in electrical communication with a power source such as a battery or an ignition circuit of a motor vehicle on which the heating pads are installed.

When the heating pads are on, the heating elements on the gloves and the heating pads can produce heat while the contact points of the gloves are in direct contact with the contact points of the heating pads. Thus, if the contact points of the gloves are not in direct contact with the contact points of the heating pads, the heating elements cannot produce heat. When the contact points of the gloves directly contact the contact points of the heating pads, the heating elements of the heating pads and the gloves establish a complete electrical circuit. Thereafter, power is supplied to the heating elements of the heating pads and the gloves, enabling the heating elements to produce heat. In this way, the gloves and the heating pads need not be connected via wires or other physical connection means, providing convenience to the user by increasing the user's mobility when riding a vehicle.

### DESCRIPTION OF THE PRIOR ART

Devices have been disclosed in the prior art that claim motorcycle riding gloves. These include devices that have been patented and published in patent application publications. Some of these devices disclose gloves with imbedded heating element. Other devices disclose motorcycle handle bars that can be heated. These devices, however, do not disclose a heating system that comprises heated gloves and handle bars that are used concurrently to activate the heating system. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 4,950,868 to Moss and U.S. Pat. No. 3,569,666 to Balz disclose heating gloves with imbedded heating elements. The heating elements are disposed in the palm section and finger sections of the gloves. The gloves are powered via batteries. Moss further discloses a reflective foil lining for retaining heat within the interior of the gloves. Some devices in the prior art disclose heating gloves that comprise heating elements in specific areas of the glove. For example, U.S. Pat. No. 5,620,621 to Sontag discloses gloves having heating element located in the palm region. The foregoing devices, however, do not disclose heating gloves that are used in conjunction with heating pads that are installed on the handle bars of a motor vehicle.

Conversely, U.S. Pat. No. 7,189,943 to Richlen (Richlen '943) and U.S. Pat. No. 6,984,807 to Richlen (Richlen '807) disclose heated motorcycle handgrips. The handgrips comprise a grip housing having heating elements therein. The grip housing can be disposed over a handle bar of a motorcycle. The heating elements are controlled via a heater control dial disposed on the grip housing. Another prior art device, U.S. Pat. No. 6,844,524 to Downey discloses heated handle bars with temperature control. The handle bars comprise a hollow core having a control circuit, which includes a microprocessor and a temperature sensor. The foregoing devices, however, does not disclose heated handgrips that are used in conjunction with a pair of heated gloves.

The devices disclosed in the prior art are disadvantageous in that the gloves require an internal power source to activate the heating elements imbedded therein. Similarly, the heated handle bars must be installed so that the handle bars are in electrical communication with the motorcycle on which it is installed to receive power therefrom. Additionally, heated handle bars are limited in the fact that it only heats the palm portion of the user's hands, leaving the back of the user's hands exposed in the wind or in cold weather.

The present invention overcomes these limitations by disclosing a heating system comprising a pair of gloves and a pair of handle bar heating pads. Each of the gloves and the heating pads comprises heating elements imbedded therein. Further, the gloves and the heating pads comprise a plurality of contact points that is used to activate the heating system. A first set of contact points is located on the palm portion and on the underside of the pinky portion of the gloves. A second set of contact points is disposed on the handle bar in locations that correspond with the palm portion and the pinky portion of the gloves when the user's hand is grasping the heating pads. The first and second set of contact points need only be in direct contact to actuate the heating elements. Thus, the heating elements may be actuated without a wire connection or other physical connection means. Additionally, the present invention is designed to increase the versatility of the heated glove by providing one that can be utilized with a number of different heating pads installed on different vehicles.

It is therefore submitted that the present invention is substantially divergent in design elements from the prior art, and consequently it is clear that there is a need in the art for an improvement to motorcycle riding gloves. In this regard, the instant invention substantially fulfills these needs.

### SUMMARY OF THE INVENTION

In view of the foregoing disadvantages inherent in the known types of motorcycle riding gloves now present in the prior art, the present invention provides a new and improved wireless heating system for motor vehicles wherein the same can be utilized for providing heat to the user's hands when riding a motorcycle.

It is therefore an object of the invention to provide a new and improved wireless heating system for motor vehicles that has all of the advantages of the prior art and none of the disadvantages.

Another object of the present invention is to provide a new and improved wireless heating system for motor vehicles having a pair of gloves and a pair of handle bar heating pads, wherein the gloves can contact the heating pads to activate the heating system.

Yet another object of the present invention is to provide a new and improved wireless heating system for motor vehicles comprising motorcycle riding gloves with contact points on the pinky portion and the palm portion of the gloves.

Yet another object of the present invention is to provide a new and improved wireless heating system for motor vehicles comprising handle bar heating pads with contact points that are disposed on locations that correspond to the pinky portion and the palm portion of a user's hands when grasping the handle bar heating pads.

Still yet another object of the present invention is to provide a new and improved wireless heating system for motor vehicles comprising a pair of gloves and handle bar heating pads with imbedded heating elements.

Still yet another object of the present invention is to provide a new and improved wireless heating system for motor vehicles that can be installed on existing motor vehicles such as motorcycles, ATVs, motor bikes, and the like.

Still yet another object of the present invention is to provide a new and improved wireless heating system for motor vehicles that can wirelessly provide heat to the user's hands.

Still yet another object of the present invention is to provide a new and improved wireless heating system for motor vehicles wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a view of the glove of the present invention.

FIG. 2 shows a transparent view of the glove and the handle bar heating pad of the present invention.

FIG. 3 shows a schematic diagram of the present wireless heating system for motor vehicles.

### DETAILED DESCRIPTION OF THE INVENTION

References are made herein to the attached drawings. Like reference numerals are used throughout the drawings to depict like or similar elements of the wireless heating system for motor vehicles. For the purposes of presenting a brief and clear description of the present invention, the preferred embodiment will be discussed as used to provide heat to the user's hands when riding a motorcycle. The figures are intended for representative purposes only and should not be considered to be limiting in any respect.

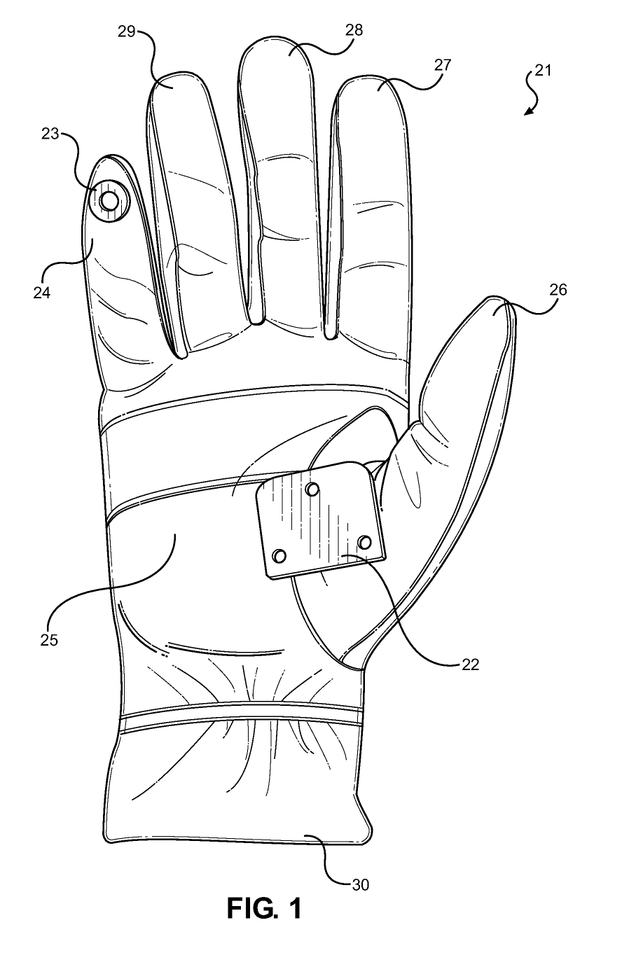

Referring now to FIG. 1, there is shown a view of the glove of the present invention. The glove 21 comprises a thumb portion 26, an index finger portion 27, a middle finger portion 28, a ring finger portion 29, and a pinky portion 24, each of the finger portions having an underside that correspond with the palm portion 25 and a back side that correspond with the back of the user's hand. The glove 21 also comprises a main opening 30 for receiving a user's hand therethrough. In the illustrated embodiment, the glove 21 is composed of leather, and comprises an outward appearance of a conventional motorcycle riding glove. However, the glove 21 may be composed of other non-flammable and non-conductive material, and may be designed to suit the user's preferences.

The glove 21 comprises an outer layer, an inner layer, and heating elements disposed therein. The inner layer of the glove 21 is composed of an insulating fabric material so as to protect the user's hand from excessive heat while retaining warmth within the interior of the glove 21. Without limitation, fabric material such as wool, acrylic, polyester, among others, may be used as an inner layer. The heating elements are disposed throughout the glove 21, namely on each of the finger portions 26, 27, 28, 29, 24, and the palm portion 25. The heating elements comprise flexible metal wires, such as copper, so that the user can easily move his or her hand while wearing the glove, and the heating elements do not restrict the movement of the user's hand.

The heating elements are in electrical communication with contact points 22, 23 disposed on the outer layer and the inner layer of the glove 21. Each of the contact points 22, 23 comprises a metal plate, or other suitable material that can conduct electricity. The first contact point 22 is located on the palm portion 25 of the glove 21, near the thumb portion 26. The first contact point 22 is substantially rectangular in shape. The second contact point 23 is located on the underside of the glove 21 at the pinky portion 24. The second contact point 23 is substantially ring shaped. The contact points 22, 23, are light in weight and preferably flat so that it does not cause discomfort to the user when the glove 21 is worn. The contact points 22, 23 are attached to the outer layer of the glove via strong adhesives, or the like. In the illustrated embodiment, the first point contact point 22 comprises a plurality of apertures thereon, so that the contact point 22 can be sewn onto the glove 21. Similarly, the second contact point 23 comprises a centrally located opening through which thread is sewn through to stitch the contact point 23 to the pinky portion 24 of the glove 21.

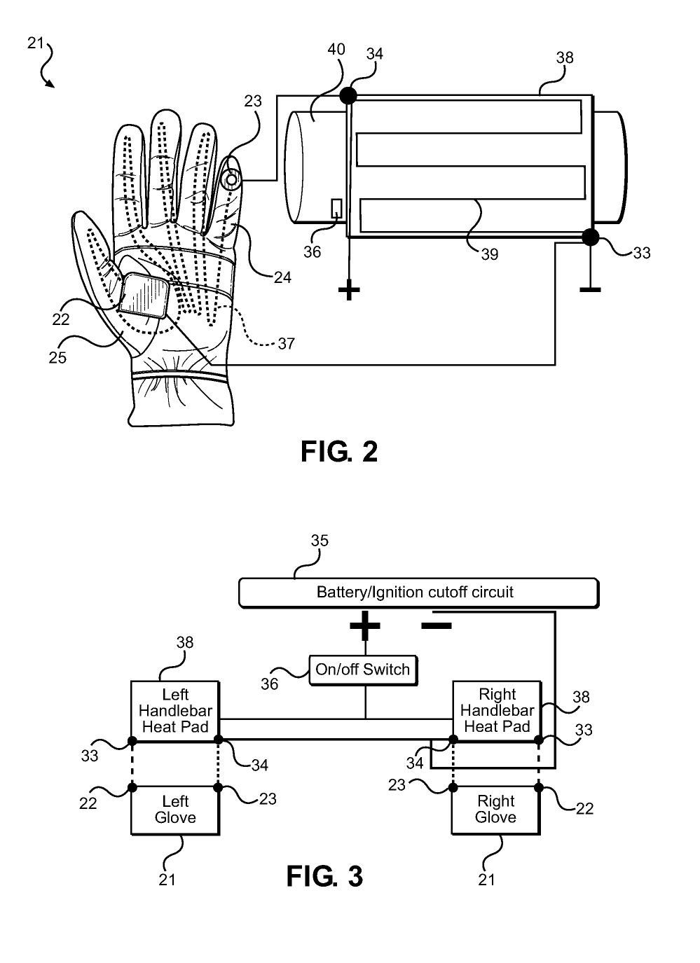

Referring now to FIG. 2, there is shown a transparent view of the glove and the handle bar heating pad of the present invention. The glove 21 comprises a first set of contact points 22, 23, wherein each of the contact points 22, 23, is connected to the heating elements 37 imbedded in the glove 21. The handle bar heating pad 38 of the present invention is substantially cylindrical in shape and comprises a hollow middle portion for receiving a portion of a motorcycle handle bar 40 therethrough. In this way, the heating pad 38 covers a portion of the handle bar 40 when installed. However, it is contemplated that the handle bar heating pad 38 may be installed on handle bars of other types of motor vehicles, including ATVs, motor bikes, and the like. Additionally, the heating pad 38 is configured so that it snugly fits around the motorcycle handle bar 40 on which it is placed. In a preferred embodiment, the heating pad 38 is composed of an insulating material such as foam, or other suitable material.

The heating pad 38 comprises heating elements 39 imbedded therein. The heating elements 39 span between the terminal ends of the heating pad 38. The heating pad 38 is configured so that it wraps around a portion of the motorcycle handle bar 40 on which it is placed. The heating elements 39 are in electrical communication with a second set of contact points 33, 34. Each of the contact points 33, 34 also comprises a metal plate, or other suitable material that can conduct electricity. The heating elements 39 of the heating pad 38 is in electrical communication with a power source and a power switch 36, wherein the power switch 36 can be actuated to operate the heating pad 38. The power switch 36 may be directly on the heating pad 38 or installed on the vehicle.

The first contact point 33 of the second set of contact points is adapted to directly align with the first contact point 22 of the first set of contact points; and the second contact point 34 of the second set of contact points is adapted to directly align with the second contact point 23 of the first set of contact points. As such, the first contact point 33 is disposed on a location of the heating pad 38 that corresponds with the palm portion 25 of the glove 21 when the user is grabbing the heating pad 38. Similarly, the second contact point 34 is disposed on a location of the heating pad 38 that corresponds with the pinky portion 24 of the glove 21 when the user is grabbing the heating pad 38.

Referring now to FIG. 3, there is shown a schematic diagram of the present wireless heating system for motor vehicles. The present wireless heating system comprises a pair of handle bar heating pads 38 and a pair of gloves 21. The heating pads 38 are electrically connected to a power switch 36 and a power source 35, which may comprise a battery or an ignition circuit of the vehicle on which it is installed. The power switch 36 is in electrical communication with the power source 35 so as to provide power to the heating pads 38. In this way, the power switch 36 controls the operation of the heating pads 38 by turning the heating pads 38 on or off. Each of the heating pads 38 may comprise a power switch 36 so that the heating pads 38 can operate independently. Alternatively, the present invention may comprise a single power switch 36 that can operate both of the heating pads 38, as depicted in FIG. 3. If a single power switch 36 is used, the heating pads 38 are in electrical communication with one another via wiring or other similar means.

Each heating pad 38 includes a second set of contact points 33, 34 that is positioned so that it aligns with a first set of contact points 22, 23 disposed on each of the gloves 21. When the heating pads 38 are turned on while the first contact points 22, 33 and the second contact points 23, 34 are in direct contact, the heating elements imbedded in the gloves 21 and the heating pads 38 establish a complete circuit. The complete circuit allows power to be supplied to the heating elements in the gloves 21 and the heating pads 38, thereby enabling the heating elements to produce heat.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless heating system for motor vehicles, comprising:
a glove having a first set of contact points attached thereto;
a handle bar heating pad having a second set of contact points attached thereto;
wherein said handle bar heating pad is adapted to cover a portion of a handle bar of a motor vehicle;
each of said glove and said handle bar heating pad having heating elements imbedded therein;
said first set of contact points in electrical communication with said heating elements of said glove;
said second set of contact points in electrical communication with said heating elements of said handle bar heating pad;
said heating elements of said handle bar heating pad in electrical communication with a power source;
wherein said heating elements of said glove and said heating elements of said handle bar heating pad are actuated when said first set of contact points directly contact said second set of contact points.

2) The wireless heating system for motor vehicles of claim 1, wherein said power source comprises batteries.

3) The wireless heating system for motor vehicles of claim 1, wherein said power source comprises ignition circuit.

4) The wireless heating system for motor vehicles of claim 1, further comprising a power switch disposed on an exterior of said handle bar heating pad;
said power switch in electrical communication with said power source and said heating elements of said handle bar heating pad.

5) The wireless heating system for motor vehicles of claim 1, wherein said first set of contact points comprise a first contact point and a second contact point;
said first contact point on a palm portion of said glove;
said second contact point on an underside of a pinky portion of said glove.

6) The wireless heating system for motor vehicles of claim 5, wherein said second set of contact points comprise a first contact point and a second contact point;
said first contact point of said second set of contact points adapted to contact said first contact point of said first set of contact points;
said second contact point of said second set of contact points adapted to contact said second contact point of said first set of contact points.

7) The wireless heating system for motor vehicles of claim 1, wherein said handle bar heating pad is substantially cylindrical in shape.

8) The wireless heating system for motor vehicles of claim 1, wherein said heating elements of said glove and said heating elements of said handle bar heating pad establish a complete circuit when said first set of contact points directly contact said second set of contact points;
whereby establishing said complete circuit allows said power source to supply power to said heating elements of said glove and said heating elements of said handle bar heating pad.
